(19) United States
(12) Patent Application Publication
(10) Pub. No.: US 2004/0019472 A1
(43) Pub. Date: Jan. 29, 2004

(54) System and method for enabling computer simulation systems

(76) Inventors: Matthew W. Jones, Frisco, TX (US); Jeffrey Naset, Allen, TX (US)

Correspondence Address: HEWLETT-PACKARD COMPANY, Intellectual Property Administration, P.O. Box 272400, Fort Collins, CO, 80527-2400, US

(21) Appl. No.: 10/202,326

(22) Filed: Jul. 24, 2002

(51) Int. Cl. G06G 7/62; G06F 17/50

(52) U.S. Cl. 703/13

(57) ABSTRACT

A system and method for addressing the problem of storing multiple copies of hard drive data in a multi-user simulation environment is described. In one embodiment, the invention takes advantage of the fact that most of the data stored on simulated hard drives is identical. Each user begins with a common starting image comprising a simulated disk on which useful software is stored. As each user's simulated machine writes to the simulated disk, changes to the starting image are recorded on a per-user basis.

### BACKGROUND OF THE INVENTION

1. Technical Field of the Invention

The present invention generally relates to computer simulation systems. More particularly, and not by way of any limitation, the present invention is directed to a system and method for enabling computer simulation systems to be run simultaneously using less storage space.

2. Description of Related Art

Computer manufacturers often use architectural simulators, which are whole-machine simulations of an entire hardware system. Such simulators include all of the data that would normally be stored on the hard drive of a simulated machine. The amount of data involved is often in the range of 250 MB to 2 GB, depending on how much software is needed to perform the simulation.

Because each user of a simulator requires a separate copy of the simulator software to be executed, the primary storage consumed is typically the hard drive data for the simulated machines. For example, assuming there are twenty users and that the hard drive data for each machine is 2 GB, a total of 40 GB of space would be needed to support the twenty users. Clearly, this is an immense amount of data to maintain and back up.

### SUMMARY OF THE INVENTION

Accordingly, the present invention advantageously provides a system and method for addressing the problem of storing multiple copies of hard drive data in a multi-user simulation environment. In one embodiment, the invention takes advantage of the fact that most of the data stored on simulated hard drives is identical.

Each computer simulation (i.e., a user) begins with a common starting image comprising a simulated disk on which is stored useful software. As each user's simulated machine writes to the simulated disk, changes to the starting image are recorded on a per-user basis. Accordingly, booting the operating system of each simulated machine requires only about 2 MB of data per user, as opposed to approximately 2 GB for the whole disk image. In one aspect, the invention is directed to a method of operating a computer simulation system including a read-only file comprising a predetermined number of blocks of equal size, a work file, and a plurality of array entries each of which corresponds to a different one of the blocks of the read-only file, the method comprising the steps of, responsive to receipt of a command identifying a block of the read-only file, determining whether the array entry corresponding to the identified block of the read-only file is dirty; if the corresponding array entry is dirty and the received command is a read command, reading data from the work file; and if the corresponding array entry is not dirty and the received command is a read command, reading data from the identified block of the read-only file.

In another aspect, the invention is directed to a computer simulation system comprising simulation software, a read-only file comprising a predetermined number of blocks of equal size, a work file, and an array including a number of entries each of which corresponds to a different one of the blocks of the read-only file. The invention further includes means responsive to receipt of a command issued by the simulation software identifying a block of the read-only file for determining whether the array entry corresponding to the identified block has stored therein a pointer identifying a block of the work file, means for reading data from the block of the work file identified by the pointer if the corresponding array entry is dirty and the received command is a read command, and means for reading data from the identified block of the read-only file if the corresponding array entry is not dirty and the received command is a read command.

In another aspect, the invention is directed to a computer simulation system comprising simulation software, a read-only file comprising a predetermined number of blocks of equal size, a work file including an array, wherein the array includes a number of entries each of which corresponds to a different one of the blocks of the read-only file, and an I/O driver for intercepting read and write commands generated by the simulation software. Responsive to interception of a command from the simulation software identifying a block of the read-only file, the I/O driver determines whether the array entry corresponding to the identified block has stored therein a pointer identifying a block of the work file. The I/O driver reads data from the block of the work file identified by the pointer if the corresponding array entry has stored therein a pointer and the received command is a read command. The I/O driver reads data from the identified block of the read-only file if the corresponding array entry does not have a pointer stored therein and the received command is a read command.

### BRIEF DESCRIPTION OF THE DRAWINGS

A more complete understanding of the present invention may be had by reference to the following Detailed Description when taken in conjunction with the accompanying drawings wherein:

FIG. 1A is a functional block diagram of a simulation system for implementing one embodiment of the present invention;

FIG. 1B is a functional block diagram illustrating the correspondence between a SCSI array and a read-only disk image forming a portion of the simulation system of FIG. 1A;

FIG. 2 is a flowchart of the operation of the simulation system of FIG. 1A in accordance with one embodiment; and

FIGS. 3A-3C illustrate an example of the operation of the simulation system of FIG. 1A in accordance with one embodiment.

### DETAILED DESCRIPTION OF THE DRAWINGS

In the drawings, like or similar elements are designated with identical reference numerals throughout the several views thereof, and the various elements depicted are not necessarily drawn to scale.

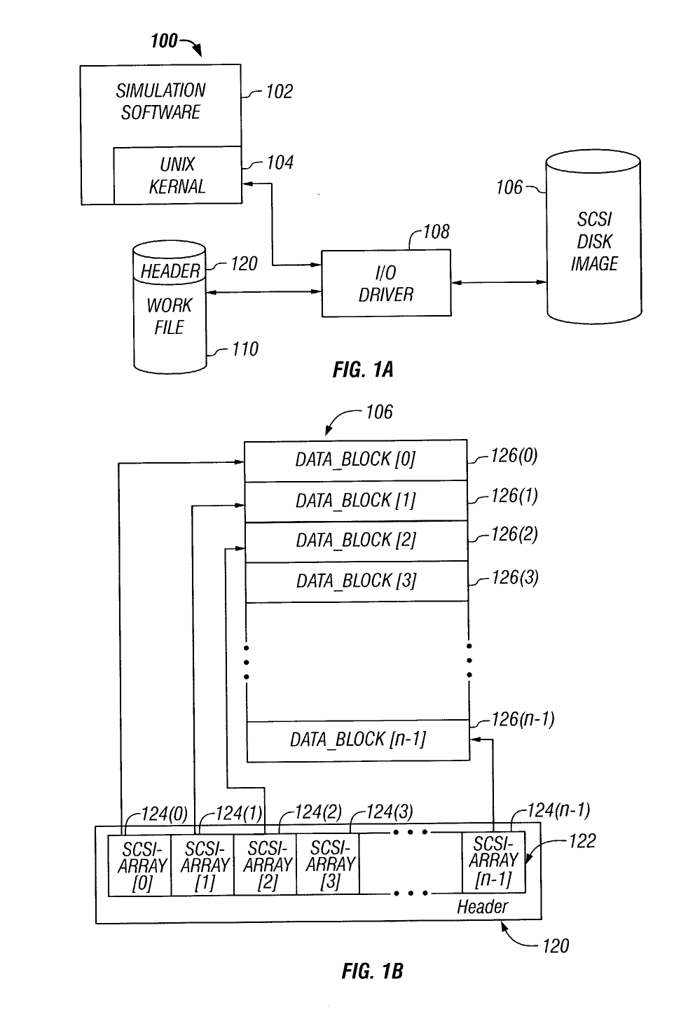

FIG. 1A is a functional block diagram of a simulation system 100 for implementing one embodiment of the present invention. The simulation system 100 includes at least one copy of simulation software 102 including an OS kernel 104 such as a Unix kernel. The simulation system 100 further includes a read-only file comprising a SCSI disk image 106 of an actual hard disk of a machine being simulated by the simulation system 100. In the embodiment described herein, the image 106 is 2 GB data file. In accordance with features of one embodiment, an extension of the kernel 104 comprising an I/O driver 108 intercepts disk READ and WRITE commands issued by the simulation software 102 that would normally result in data being read from and written to the simulated SCSI disk comprising the image 106.

The simulation system 100 also includes a temporary work file 110. In accordance with one embodiment, the image 106 is mapped to a number of data blocks of a predetermined size (e.g., 4 KB to 64 KB). For purposes of example, it will be assumed that the image 106 is mapped to 16 KB blocks. As best illustrated in FIG. 1B, a header 120 of the work file 110 includes an array, or table, 122 (designated “scsi_array”) comprising n entries 124(0)-124(n−1), where n is equal to the size of the image 106 (e.g., 2 GB) divided by the size of the data blocks to which the image 106 is mapped (e.g., 16 KB). Accordingly, in the embodiment illustrated herein, the value of n is 2 GB/16 KB, or 65,536. Each of the entries 124(0)-124(n−1) corresponds to one of the n 16 KB blocks 126(0)-126(n−1) of the image 106. Specifically, the first entry 124(0) (“scsi_array[0]”) maps to the first block 126(0) (“block[0]”) comprising offset addresses 0 to (16 KB−1B). A second entry 124(1) (“scsi_array[1]”) maps to a second block 126(1) (“block[1]”) comprising offset addresses 16 KB to (32 KB−1B), and so on, with the nth entry 124(n−1) (“scsi_array[n−1] mapping to the nth block 126(n−1) (“block [n−1]”) comprising offset addresses (2 GB−16 KB) to (2 GB−1B). For purposes that will be described in greater detail below, a pointer to a data block within the work file 110 may be written to any of the array entries 124(0)-124(n−1).

Referring again to FIG. 1A, it should be recognized that the simulation system 100 may include more than one copy of the simulation software 102, along with corresponding additional copies of the work file 110 and the I/O driver 108, each of which independently reads from/writes to a single copy of the image 106 in the manner described herein.

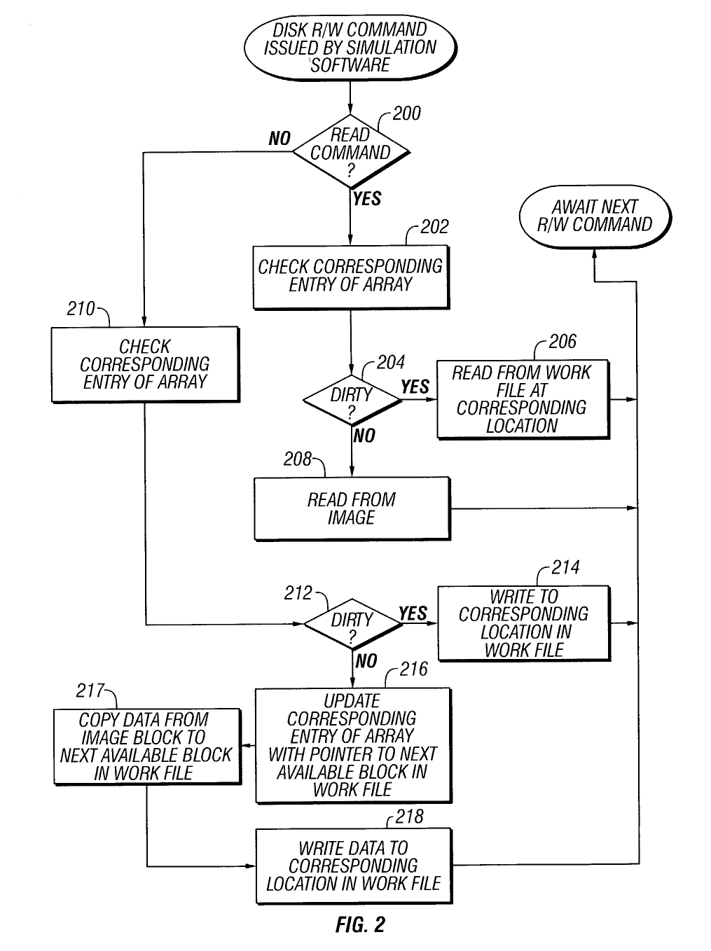

FIG. 2 is a flowchart of the operation of the simulation system of the present invention in accordance with one embodiment. Execution begins responsive to interception by the I/O driver 108 of a SCSI disk READ or WRITE command from the simulation software 102. In step 200, a determination is made whether the intercepted command is a READ command. If so, execution proceeds to step 202, in which a determination is made as to which of the 16 KB blocks 126(0)-126(n−1) the READ address maps; that is, within the range of addresses where the READ address falls. In step 204, the entry of the array 122 that corresponds to the block identified in step 202 is checked to determine whether the identified block is “dirty” or “contaminated” or otherwise indicated, i.e., it has already been written to. In particular, if the entry of the array 122 corresponding to the identified data block contains a “0”, the identified block is “clean” (i.e., has not been written to). If the entry of the array 122 corresponding to the identified data block contains anything other than a “0”, the entry comprises a pointer to a data block within the work file 110 that corresponds to the identified block within the image 106.

Accordingly, if in step 204 it is determined that the identified block is dirty, execution proceeds to step 206, in which data is read from the data block of work file 110 pointed to by the pointer contained in the array entry corresponding to the data block of the image 106 identified in step 202. Conceptually, this results in the contents of the data block of the work file 110 pointed to by the pointer being substituted for the contents of the corresponding data block of the image 106. In contrast, if a negative determination is made in step 204, execution proceeds to step 208, in which the data is read directly from the image 106.

If a negative determination is made in step 200, meaning that the intercepted command is a WRITE command, execution proceeds to step 210. In step 210, a determination is made as to which of the 16 KB blocks 126(0)-126(n−1) the WRITE address corresponds to; that is, to which of the blocks does the simulation software 102 want to write data. In step 212, the entry of the array 122 that corresponds to the block identified in step 210 is checked to determine whether the identified block is “dirty,” i.e., has already been written to. If so, execution proceeds to step 214, in which the WRITE data is written to the data block of work file pointed to by the pointer contained in the array entry corresponding to the data block of the image 106 identified in step 210. In contrast, if a negative determination is made in step 212, execution proceeds to step 216, in which a pointer to the next available data block of the work file 110 is entered in the array entry corresponding to the 16 KB block of the image 106 identified in step 210. In step 217, the data comprising the block of the image 106 identified in step 210 is written to the next available data block of the work file 110. In step 218, the WRITE data is written to the work file 110 within the data block thereof pointed to by the pointer value comprising the corresponding array entry. The location of the WRITE data within the block is specified by the WRITE address. Conceptually, this results in the data block of the work file 110 pointed to by the pointer being substituted for the corresponding data block of the image 106.

Upon completion of any of steps 206, 208, 214, or 218, the I/O driver 108 awaits issuance by the simulation software 102 of the next READ/WRITE command.

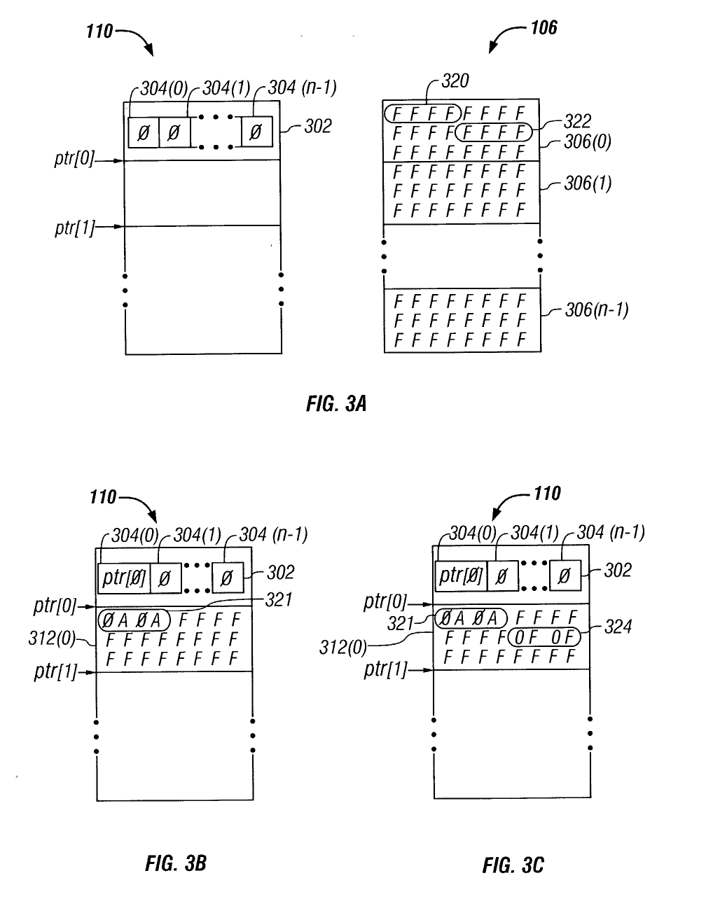

A highly simplified example of one embodiment of the present invention as described hereinabove will now be provided with reference to FIGS. 3A-3C. Referring first to FIG. 3A, it will be assumed for the purpose of illustration that a work file 110 including a scsi_array 302 comprising n entries 304(0)-304(n−1), which respectively correspond to n data blocks 306(0)-306(n−1) of an image file 106, has been set up. It will also be assumed that each of the entries 304(0)-304(n−1) contains a zero, indicating that no data has been written to the work file 110. It will be further assumed that each of the blocks 304(0)-304(n−1) and 306(0)-306( n−1) are 12 bytes (as opposed to the more typical 16 KB) in size, that data is represented therein in the drawings in hexadecimal notation, and that two bytes of data at a time are read from and written to the simulated disk.

At this point, it will be assumed that a first READ command is issued by the simulation software and intercepted by the I/O driver. It will be further assumed that the READ address falls within the address range comprising the first data block 306(0) corresponding to a location 320. Accordingly, since the entry of the array 302 corresponding to the data block 306(0) (i.e., entry 304(0)) contains a “0”, data “FFFFh” is read directly from the image file 106 at the location 320 corresponding to the READ address.

Referring to FIG. 3A, it will be assumed that a first WRITE command is issued by the simulation software and intercepted by the I/O driver and that the WRITE address falls within the address range comprising the first data block 306(0) and corresponds to the location 320. Accordingly, since the entry of the array 302 corresponding to the data block 306(0) (i.e., entry 304(0)) does not contain a pointer, a pointer “ptr[0]” to the beginning of a next available data block of the work file 110, which in this case will be a first data block 312(0), is entered in the array entry scsi_array[0], as illustrated in FIG. 3B. Next, all of the data comprising the image data block 306(0) is written to the work file data block 312(0). Additionally, the WRITE data, assumed for the sake of this example to be “0A0Ah,” is written to the data block of the work file 110 pointed to by the pointer ptr[0], i.e., data block 312(0), in the same location within the data block 312(0) as it would have been written within the data block 306(0). The WRITE data 0A0Ah will be written to a location 321 within the work file data block 312(0) that corresponds to the location 320 within the image file data block 306(0). FIG. 3B represents the contents of the scsi_array 302 and work file 110 following execution of the first WRITE command in accordance with one embodiment.

Referring to FIG. 3B, it will be assumed that a second READ command is issued by the simulation software and intercepted by the I/O driver and that the READ address of this command falls within the address range comprising the first data block 306(0) and corresponds to the location 320. Accordingly, since the entry 304(0) now does contain a pointer (ptr[0]), data will be read from the data block of the work file 110 to which the pointer ptr[0] points, in this case, the first data block 312(0), rather than from the corresponding data block 306(0) of the image file 106. Accordingly, 0A0Ah, rather than FFFFh, will be sent to the simulation software.

Referring to FIG. 3B, it will be assumed that a second WRITE command is issued by the simulation software and intercepted by the I/O driver and that the WRITE address of this command falls within the address range comprising the first data block 306(0) and corresponds to a location 322 (FIG. 3A) within the image data block 306(0). Accordingly, since the entry 304(0) now does contain a pointer (ptr[0]), WRITE data (e.g., 0F0Fh) is written to the data block of the work file 110 to which the pointer ptr[0] points, in this case, the first data block 312(0), in a location 324 corresponding to the location 322. The end result is illustrated in FIG. 3C.

An implementation of the invention described herein thus provides a computer hardware simulation system and method that utilizes less storage than a conventional system of the same type. It is believed that the operation and construction of the present invention will be apparent from the foregoing Detailed Description. While the system and method shown and described have been characterized as being preferred, it should be readily understood that various changes and modifications could be made therein without departing from the scope of the present invention as set forth in the following claims. For example, as previously indicated, it will be recognized more than one copy of the simulation software, and corresponding I/O driver and work file, could be advantageously provided in the simulation system comprising a single copy of the disk image. Further, the simulation software is operable to simulate any type of target hardware platforms including, for example, symmetrical and asymmetrical multiprocessing systems and the like. In addition, the OS kernel provided as part of the simulation system can also include any OS other than a Unix kernel. Accordingly, all such modifications, extensions, variations, amendments, additions, deletions, combinations, and the like are deemed to be within the ambit of the present invention whose scope is defined solely by the claims set forth hereinbelow.

What is claimed is:

1. A method of operating a computer simulation system including a read-only file comprising a predetermined number of blocks, a work file, and a plurality of array entries each of which corresponds to a different one of the blocks of the read-only file, the method comprising:
responsive to receipt of a command identifying a block of the read-only file, determining whether the array entry corresponding to the identified block of the read-only file is dirty;
if the corresponding array entry is dirty and the received command is a read command, reading data from the work file; and
if the corresponding array entry is not dirty and the received command is a read command, reading data from the identified block of the read-only file.

2. The method of claim 1 further comprising the steps of:
if the corresponding entry of the array is dirty and the received command is a write command specifying data to be written to a file, writing the specified data to the work file.

3. The method of claim 2 further comprising the steps of, if the corresponding entry of the array is not dirty and the command is a write command specifying data to be written to a file:
marking the corresponding entry of the array dirty;
copying data from the identified block of the read-only file to the work file; and
writing the specified data to the work file subsequent to the step of copying.

4. The method of claim 1 wherein the step of determining whether the corresponding array entry is dirty comprises the step of determining whether the corresponding array entry has stored therein a pointer identifying a block of the work file.

5. The method of claim 4 wherein the step of reading data from the work file comprises the step of reading data from the block of the work file identified by the pointer.

6. The method of claim 2 wherein the step of determining whether the corresponding array entry is dirty comprises the step of determining whether the corresponding array entry has stored therein a pointer identifying a block of the work file and wherein the step of writing the specified data to the work file comprises the step of writing the specified data to a block of the work file identified by the pointer.

7. The method of claim 3 wherein the step of determining whether the corresponding array entry is dirty comprises the step of determining whether the corresponding array entry has stored therein a pointer identifying a block of the work file.

8. The method of claim 7 wherein the step of marking the corresponding array entry dirty comprises the step of storing in the corresponding array entry a pointer to a next available block in the work file.

9. The method of claim 7 wherein the step of copying data from the identified block of the read-only file to the work file comprises the step of copying data from the identified block of the read-only file to the next available block in the work file.

10. The method of claim 7 wherein the step of writing the specified data to the work file comprises the step of writing the specified data to the next available block in the work file.

11. A computer simulation system comprising:
a read-only file comprising a predetermined number of blocks;
a work file;
an array including a number of entries each of which corresponds to a different one of the blocks of the read-only file;
means responsive to receipt of a command identifying a block of the read-only file for determining whether the array entry corresponding to the identified block has stored therein a pointer identifying a block of the work file;
means for reading data from the block of the work file identified by the pointer if the corresponding array entry is dirty and the received command is a read command; and
means for reading data from the identified block of the read-only file if the corresponding array entry is not dirty and the received command is a read command.

12. The computer simulation system of claim 11 further comprising means for writing data to a block of the work file identified by the pointer if the corresponding entry of the array is dirty and the received command is a write command specifying data to be written to a file.

13. The computer simulation system of claim 12 further comprising:
means for storing in the corresponding array entry a pointer to a next available block in the work file if the corresponding entry of the array is not dirty and the command is a write command specifying data to be written to a file;
means for copying data from the identified block of the read-only file to the next available block in the work file; and
means for writing the specified data to the next available block in the work file subsequent to the copying.

14. The computer simulation system of claim 11 further comprising simulation software.

15. The computer simulation system of claim 14 wherein the received command is issued by the simulation software.

16. A computer simulation system comprising:
simulation software;
a read-only file comprising a predetermined number of blocks of equal size;
a work file including an array, wherein the array includes a number of entries each of which corresponds to a different one of the blocks of the read-only file; and
an I/O driver for intercepting read and write commands generated by the simulation software;
wherein responsive to interception of a command from the simulation software identifying a block of the read-only file, the I/O driver determines whether the array entry corresponding to the identified block has stored therein a pointer identifying a block of the work file;
wherein the I/O driver reads data from the block of the work file identified by the pointer if the corresponding array entry has stored therein a pointer and the received command is a read command; and
wherein the I/O driver reads data from the identified block of the read-only file if the corresponding array entry does not have a pointer stored therein and the received command is a read command.

17. The computer simulation system of claim 16 wherein if the corresponding entry of the array is dirty and the received command is a write command specifying data to be written to a file, the I/O driver writes the specified data to a block of the work file identified by the pointer.

18. The computer simulation system of claim 16 wherein if the corresponding entry of the array is not dirty and the command is a write command specifying data to be written to a file, the I/O driver stores in the corresponding array entry a pointer to a next available block in the work file.

19. The computer simulation system of claim 18 wherein the I/O driver copies data from the identified block of the read-only file to the next available block in the work file.

20. The computer simulation system of claim 18 wherein the I/O driver writes the specified data to the next available block in the work file subsequent to the copying.
